(19) United States
(12) Patent Application Publication
(10) Pub. No.: US 2019/0020969 A1
(43) Pub. Date: Jan. 17, 2019

(54) SYSTEMS AND METHODS FOR PROVISION OF VIRTUAL MOBILE DEVICES IN A NETWORK ENVIRONMENT

(71) Applicant: AT&T Intellectual Property I, L.P., Atlanta, GA (US)

(72) Inventors: Eric Zavesky, Austin, TX (US); Jason Decuir, Cedar Park, TX (US); Robert Gratz, Lockhart, TX (US)

(21) Appl. No.: 15/646,595

(22) Filed: Jul. 11, 2017

(51) Int. Cl. H04W 4/00; H04M 1/725; H04L 29/06

(52) U.S. Cl. CPC H04W 4/001; H04M 1/72522; H04L 67/303; H04L 65/1069; H04L 65/601

(57) ABSTRACT

Systems and methods for providing virtual mobile device services over a network to a mobile endpoint device. In response to the user input, at least one network resource and at least one virtual machine (VM) are identified to generate in response to the user input. At least one network resource is utilized to instantiate the at least one VM and generate the response to the user input. An audiovisual data stream is generated representing the response to the user input. The audiovisual data stream is caused to be output from the mobile endpoint device.

### TECHNICAL FIELD

This disclosure relates generally to network management and, more specifically, to assigning and configuring general purpose hardware to support virtual mobile devices.

### BACKGROUND

As the use of mobile devices has become more and more popular, there has been a corresponding increase in the number of functions that that mobile devices are expected to support. Mobile devices began as a way for individual users to conduct mobile telephone conversations. To support such communication, a mobile device needed a limited amount of hardware: A transceiver, a microphone, a speaker, and a relatively simple user interface, such as a keypad and display screen. Over time, however, users began to use mobile devices to engage in text based communications and eventually audiovisual communications. Eventually, mobile device designs migrated to what are currently referred to as smart phones and tablet devices. These devices came bundled with a software ecosystem that users expected to perform an ever increasing number of functions, such as operating as cameras, gaming platforms, document processing platforms, banking terminals, e-readers, and so forth.

One problem associated with the use of mobile devices for such a wide variety of functions is that it is very burdensome to continually maintain and upgrade the hardware and software that is necessary for the devices to achieve maximum performance. For example, a mobile device that is used as a gaming platform may start to experience sluggish performance as developers write more and more robust experiences into their games. This causes demand for new devices with faster processors and additional hardware to support the new experiences.

Eventually, the older devices become obsolete because software is tailored to hardware of the most recent devices. When users of older devices update their operating systems or applications software, they find that their devices do not operate as well as they did on the prior operating. If possible, such users may return to their prior software versions, but then they are denied the benefit of the most up to date versions of their applications.

Therefore, in the present paradigm, many device manufacturers create devices that attempt to be all things to everybody by packing the devices with hardware that not all of their customers utilize. This makes devices more expensive than necessary for some users. If manufacturers do not pack their devices with the latest hardware, then other users will not have devices that meet their needs. Therefore, there is a need for the systems and methods described in the present disclosure for provision virtual mobile devices within a network environment.

### SUMMARY

Systems and methods for providing virtual mobile device services over a network to a mobile endpoint device. In response to the user input, at least one network resource and at least one virtual machine (VM) are identified to generate in response to the user input. At least one network resource is utilized to instantiate the at least one VM and generate the response to the user input. An audiovisual data stream is generated representing the response to the user input. The audiovisual data stream is caused to be output from the mobile endpoint device.

### BRIEF DESCRIPTION OF THE DRAWINGS

In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1A is a representation of an exemplary system for provision of virtual mobile devices in a network environment.

FIG. 1B is a representation of a virtual mobile device and end point devices as set forth in FIG. 1a.

FIG. 1C is a representation of an exemplary hardware platform that may be utilized in the system of FIG. 1A.

FIG. 1D is a representation of a system for managing virtual mobile devices within the system of FIG. 1A.

FIG. 2A depicts an exemplary process for provision of virtual mobile devices according to one example.

FIG. 2B is a flowchart depicting an exemplary embodiment of the process of FIG. 2A.

FIG. 2C is an exemplary embodiment of the system of FIG. 1A.

FIG. 3 is a representation of a network device according to an example.

FIG. 4 depicts an exemplary communication system that provide wireless telecommunication services over wireless communication networks that may be at least partially virtualized.

FIG. 5 depicts an exemplary diagrammatic representation of a machine in the form of a computer system.

FIG. 6 is a representation of a telecommunications network.

FIG. 7 is a representation of a core network.

FIG. 8 is a representation packet-based mobile cellular network environment.

FIG. 9 is a representation of a GPRS network.

FIG. 10 is a representation a PLMN architecture.

### DETAILED DESCRIPTION

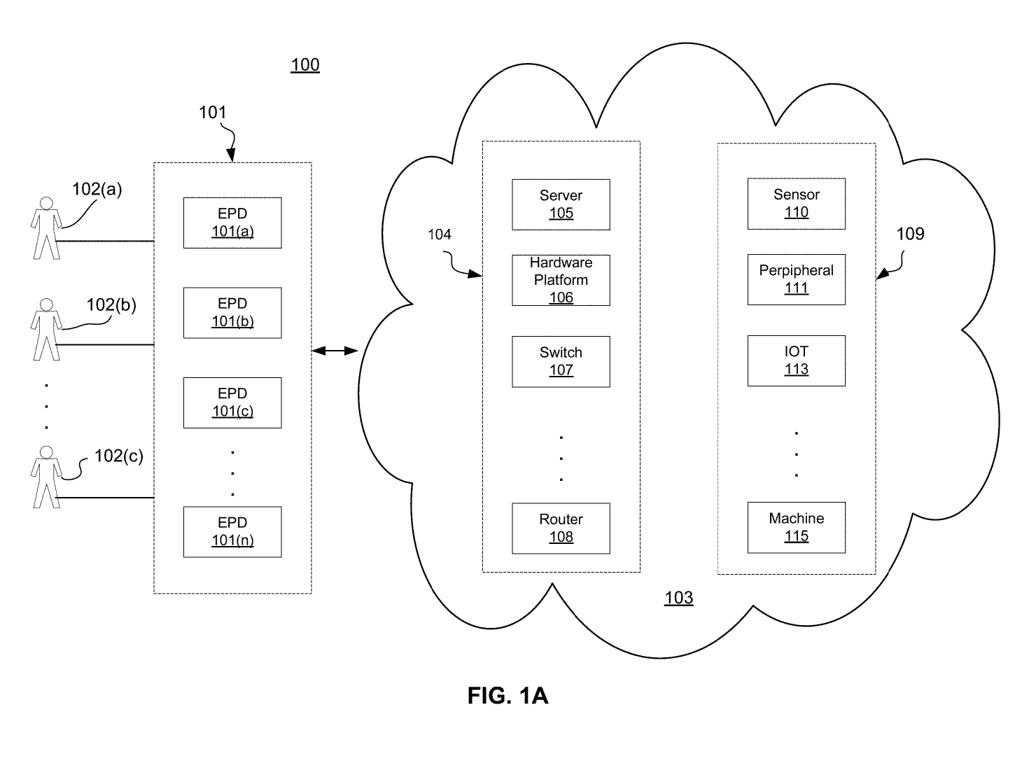

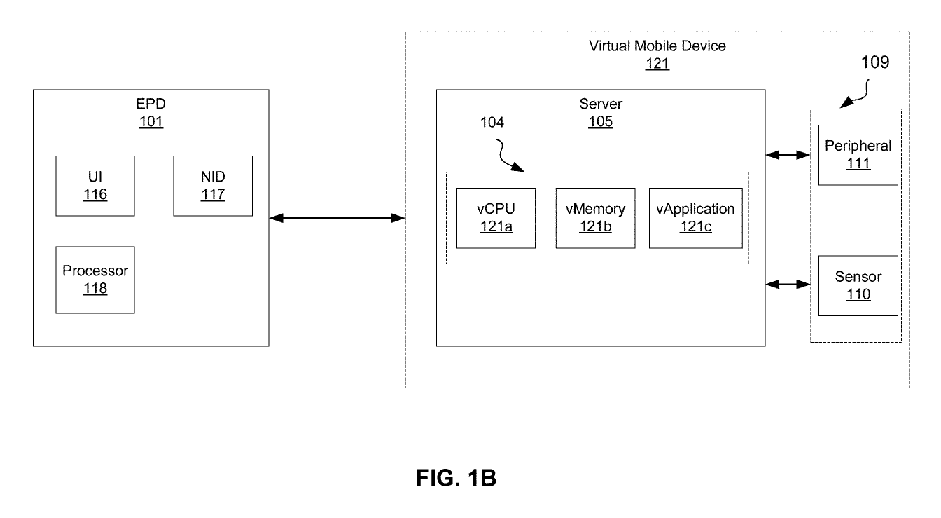

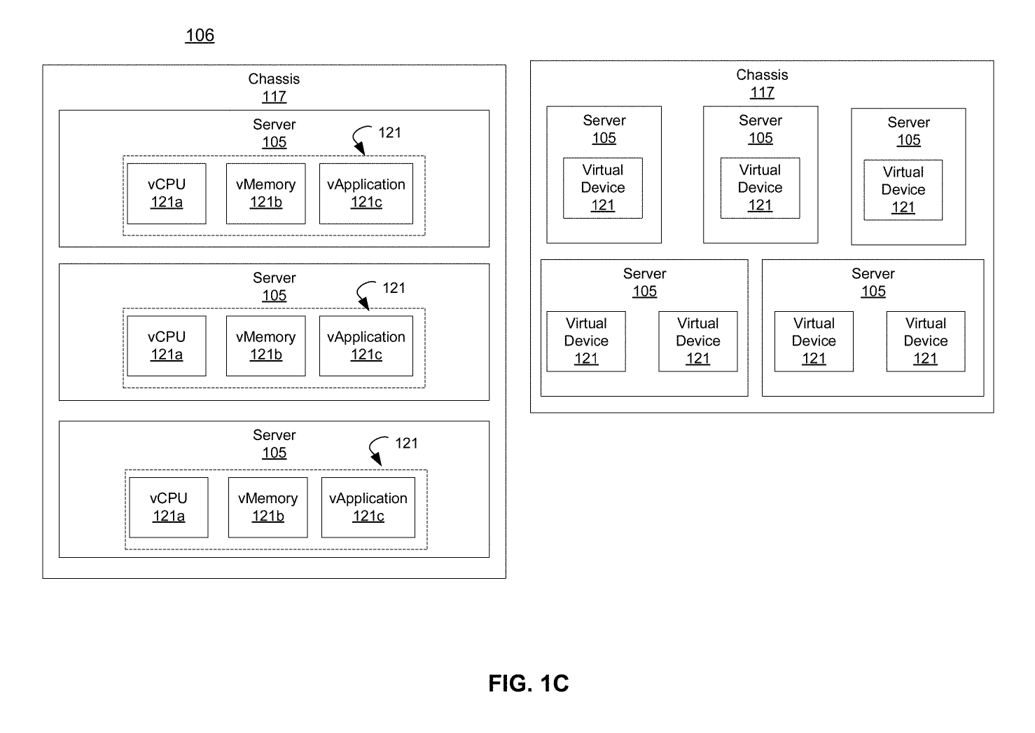

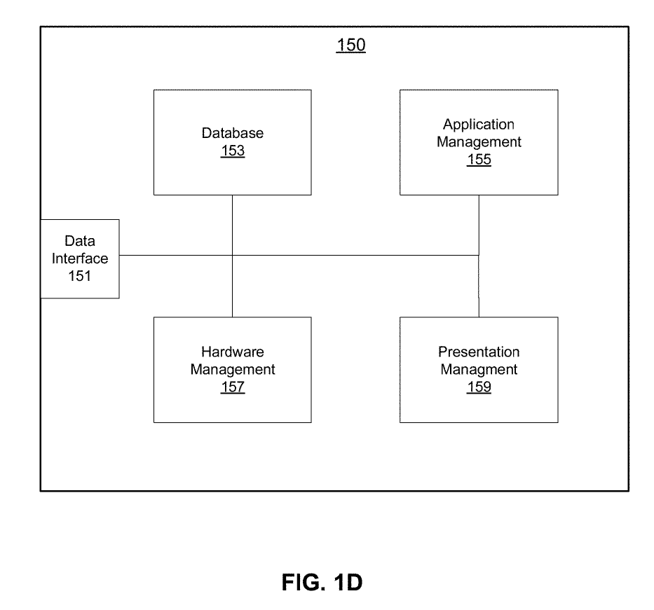

FIG. 1A is a representation of an exemplary system 100. System 100 may include one or more mobile end point devices (EPDs) 101, one or more users 102, and a network 103 of devices 104, 109.

An EPD 101, in one example, may be a mobile terminal device. An example of a mobile terminal device may be user equipment that is portable to the user with the limited purpose of driving an output user interface (UI), such as an audiovisual display, receive input from input UI, such as a keyboard (the output and input could be a touchscreen display), and interact with other devices over a network.

In another example, referring to FIG. 1B, an EPD 101 may include a UI 116, such as a touchscreen display, a network interface device (NID) 117, a processor 118, and other peripherals, which allow it to function as mobile telephone. In another example, EPD 101 may include one or more devices (e.g. camera and memory) to allow for creation and storage of audiovisual files. Accordingly, a particular embodiment of EPD 101 may range from a lean to more robust devices.

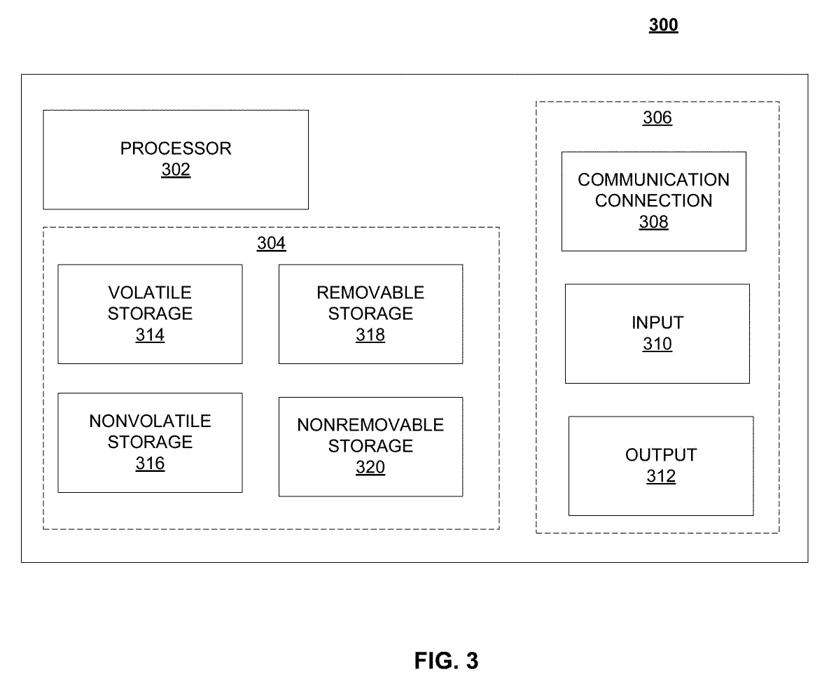

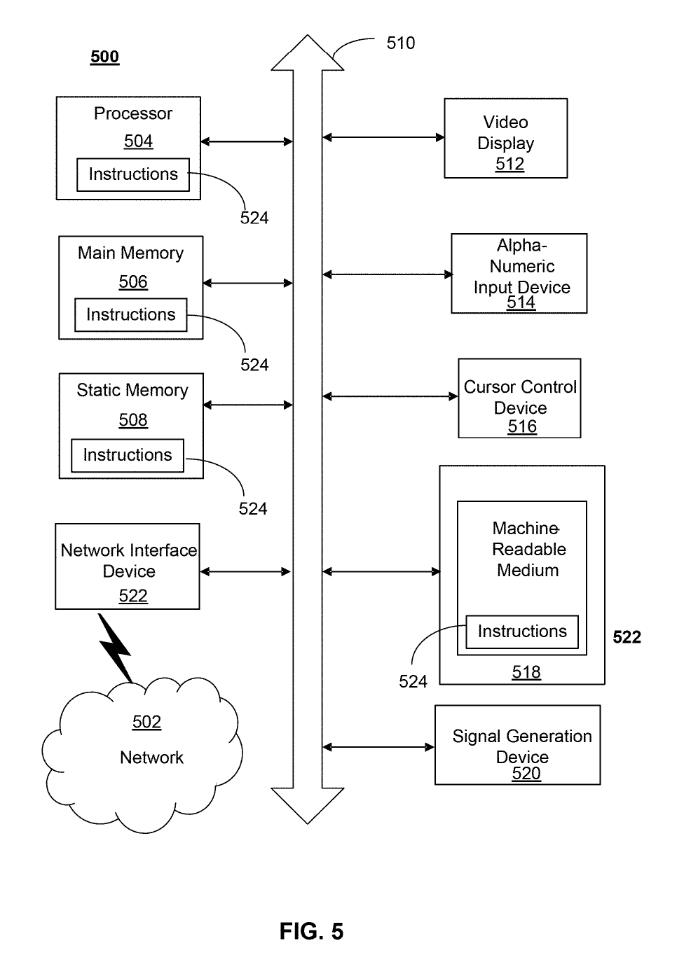

Additional examples of EPDs 101 may include smartphones, tablets, mobile computers, desktop computers and the like. More detailed illustrative embodiments of such devices are shown and described with reference to FIG. 3 and FIG. 5. In one embodiment, an EPD 101 may be a network device 300, computing system 500, or a combination thereof. In one embodiment, an EPD 101 may comprise a portion of network device 300, as shown in FIG. 3, or computing system 500, as shown in FIG. 5.

Referring now to FIG. 1A, users 102 in one embodiment are entities that may utilize one or more EPD's 101 to perform one or more functions. For instance, a user 102 may be a person who is utilizing an EPD 101 for operations that we would associate with a mobile device, such as a smartphone or a tablet. In another example, a user 102 may be an employee of an organization. In another example, a user 102 may be an entity, such as a robot, machine, or virtual machine that operates on behalf of a person or organization.

Referring further to FIG. 1A, network 103 may include a plurality of network infrastructure devices 104 and/or supplemental devices 109. Exemplary embodiments of network infrastructure devices 104 include, but are not limited to, one or more hardware servers 105, hardware platforms 106, switches 107, and routers 108. These devices are shown for illustrative purposes only and it should be understood that network infrastructure devices 104 may include other devices that are not shown for the purposes of brevity, such as base stations, mobile devices, desktop computers, and internet of things (IOT) devices. An additional discussion of network infrastructure is further provided herein. Network infrastructure devices 104 may take the form of one or more components of network device 300, computing system 500, or combinations thereof (FIGS. 3 and 5).

Supplemental devices 109 may comprise devices that provide some capability or function that users 102 may want to utilize. Further examples include sensors 110, peripherals 111, IOT devices 113, and machines 115, such as robots or vehicles (e.g. UAVs). For example, a user 102 may want to operate a machine at another location or utilize sensor data in a particular application. User 102 may not have access to such a sensor or machine so system may allow user to utilize sensor 110 or use machine 115. In another example, a user 102 may wish to capture images, but may not have a camera. Accordingly, EPD 101 may use peripheral 111 to capture an image. In the embodiment shown, supplemental devices 109 may communicate with EPDs 101 through network infrastructure devices 104. Alternatively, supplemental devices 109 may be connected directly to EPDs 101 through near field communication methods or through wired connections. Also, as noted above, to the extent, in an embodiment, that an EPD 101 includes hardware and/or software component functionality enabling it to perform a function of a supplemental device 109, then such a supplemental device 109 may be a component of EPD 101, rather than being in communication with EPD 101 over a network 103.

Referring to FIG. 1B, in one embodiment, infrastructure devices 104 and/or supplemental devices 109 may be utilized to create one or more virtual mobile devices (VMD) 121. A VMD 121 in one example is a virtual representation of a mobile device, such as a smartphone or tablet. Functionality that is conventionally performed locally on a mobile device may be virtualized and performed in network 103 through the use of infrastructure devices 104 and supplemental devices 109. Infrastructure devices 104 and/or supplemental devices 109 may perform certain functionality, on an as needed basis, and serve the output as an audiovisual stream to an EPD 101. To the extent user input is needed, a user 102 may provide input to the EPD 101, which can transmit it to the VMD operating on network 103. The EPD 101 can then process the input and provide an appropriate output stream to the EPD 101. Accordingly, users 102 will not need hardware intensive devices as in the traditional model because hardware in network 103 can be leveraged to provide mobile device functionality. In one embodiment, the preceding functionality would EPDs 101 to act as relays. For instance, one EPD 101(a) may be operating with a high capacity data connection, whereas another EPD 101(b) may be be operating with a low capacity data connection. EPD 101(a) may be utilized to relay data, such as a video stream, to EPD 101(b) if EPD 101(a) and EPD 101(b) where in proximity to each other or had a sufficient data connection.

In the example shown in FIG. 1B, a server 105 is shown as including a vCPU 121a, a virtual memory 121b, and at least one instance of a virtual application 121c. vCPU 121a in one example is a processor operating on server 105 that operates as the CPU of VMD 121. vMemory 121b is memory storage device(s) that is operating on server 105 and serve as the memory storage for VMD 121. vApplication(s) 121c are the applications, such as operating system and application specific software that user 102 utilizes when operating VMD 121. Supplemental devices 109, in the example shown, may include a peripheral device 111 and a sensor 110, but may also include IOT devices, machines, and/or other hardware the user 102 desires to use with VMD 121. By working together, infrastructure devices 104 and supplemental devices 109 provide VMD 121 functionality to user 102. In one embodiment, execution of functionality of VMD 121 is entirely performed on network 103 and a graphical representation of such functionality is output as an AV data stream to EPD 101. EPD 101 receives the data stream and renders it on an output device. In another embodiment, execution of VMD 121 is performed primarily on network 103, and EPD 101 receives an AV data stream representing a graphical user interface (GUI) which displays the GUI on EPD 101. A user 102 then can provide input on EPD 101, such as through a touchscreen, audio input, a camera, a keyboard, etc., which will then be encoded and transmitted to VMD 121 for further processing.

In the embodiment shown, server 105 may be configured as dedicated hardware to provide VMD 121 functionality to a particular EPD 101 or user 102. However, in another embodiment, virtualized functions may be implemented to create VMD 121 in lieu of having dedicated hardware for each VMD 121. That is, infrastructure devices 104 may be configured to run virtualized functions to support VMD services. For example, one or more virtualized functions may be dynamically created and terminated as needed. One example of virtualized functions are virtual network functions (VNFs) and virtual machines (VMs). In one example, a VNF is a logical concept in which one or more VMs in the aggregate perform the functionality of a VNF. Each infrastructure device 104 may include one or more VMs. Each infrastructure device 104 may include a hypervisor or the like that may be used to generate one or more VNFs and/or VMs. A VNF may have a VNF type that indicates its functionality or role. VNFs may include other types of VNFs. Each VNF may use one or more VMs to operate. A VM may include other types of VMs.

A VMD 121 may utilize one or more VNFs or VMs to perform the functions of a VMD 121. Each VMD 121 may consume various network resources from one or more devices 101. Referring to FIG. 1C, a hardware platform 106 is shown. Hardware platform 106 may comprise a collection of one or more infrastructure devices 104 (e.g. servers 105) that are operating in a geographic location. Hardware platform 106 may include on or more virtualized functions that are instantiated to perform the functions of one or more VMDs 121. Such virtualized functions may be operating in conjunction with one or more supplemental devices 109. Examples of virtualized functions include, but are not limited to, vCPUs 121a, vMemory devices 121b, and vApplications 121c. One or more hardware platforms 106 may reside in a same geographic location or they may be distributed over multiple geographic locations. While FIG. 1C illustrates resources VMDs 121 as collectively contained in a hardware platform 106, a VMD 121 may be distributed over multiple hardware platforms 106 and/or geographic locations.

Hardware platform 106 may comprise one or more chasses 117. Chassis 110 may refer to the physical housing or platform for multiple servers or other network equipment. In an aspect, chassis 117 may also refer to the underlying network equipment. Chassis 117 may include one or more servers 105. Servers 105 may comprise general purpose computer hardware or a computer. In an aspect, chassis 117 may comprise a metal rack, and servers 105 of chassis 117 may comprise blade servers that are physically mounted in or on chassis 117.

Servers 105 may be communicatively coupled together (not shown) in any combination or arrangement. For example, all servers 105 within a given chassis 117 may be communicatively coupled. As another example, servers 105 in different chasses 117 may be communicatively coupled. Additionally or alternatively, chasses 117 may be communicatively coupled together (not shown) in any combination or arrangement.

The characteristics of each chassis 117 and each server 105 may differ. For example, FIG. 1C illustrates that the number of servers 105 within two chasses 117 may vary. Additionally or alternatively, the type or number of resources within each server 105 may vary. In an aspect, chassis 117 may be used to group servers 105 with the same resource characteristics. In another aspect, servers 105 within the same chassis 117 may have different resource characteristics.

Given hardware platform 106, the number of VMDs 121 that may be instantiated or the transaction rate may vary depending upon how efficiently resources are assigned to different VMDs 121. For example, assignment of VMDs 121 to particular resources may be constrained by one or more rules. For example, a first rule may require that resources assigned to a particular VMD 121 be on the same server 105 or set of servers 105. For example, if a VMD 121 requires use of 4 vCPUs 121a, 1 GB of memory 112b, and 10 vApplications 121c, the rules may require that all of those resources be sourced from the same server 105. Additionally or alternatively, a VMD 121 may require splitting resources among multiple servers 105, but such splitting may need to conform with certain restrictions. For example, resources for a VMD 121 may be able to be split between two servers 105. Default rules may apply. For example, a default rule may require that all resources 108 for a given VMD 121 must come from the same server 105.

Referring to FIG. 1D, a system 150 for managing VMDs 121 on network 103 is provided for illustrative purposes. In one embodiment, system 150 includes data interface 151, database 153, application management component 155, hardware management component 157, and presentation management component 159. System 150 in one example may be configured to receive requests to initiate VMD 121 functionality. For example, system 150 may receive requests to instantiate VNFs and/or VMs to support VMD 121 functionality. In one embodiment, system 150 may manage VMDs 121 at one site within a network infrastructure. In another embodiment, system 150 may manage VMDs 121 at multiple sites. In another embodiment, system 150 may manage VMDs 121 for a portion of a site or a portion of multiple sites. For the purposes of brevity, in the remainder of this disclosure, the operations of system 150 may be described in the context of management of VMDs 121 at a particular site; however, it should be understood that the principles are applicable to the management of multiple sites or portions of sites within a network infrastructure.

System 150 may reside as a centralized standalone infrastructure component 104 of network 103 (FIG. 1A) or the functionality of system 150 may spread across one or more infrastructure devices 104 or supplemental devices 109 of network 103. The components of system 150 are shown for illustrative purposes only and should not be construed as limiting system 150. The functionality of system 150 may be combined or divided as appropriate. Furthermore, system 150 may be implemented using existing functional components of network 100 (e.g. hypervisors, switches, etc.)

In one embodiment, management of VMDs 121 may include receiving requests for VMD 121 functionality and implementing the VMD 121 functionality. Implementing VMD 121 functionality may include determining how, when, where, and with what resources to use to implement VMD 121 functionality. In one example, management of VMDs 121 may include detecting the need for one or more VMs and causing the VMs to be instantiated.

Referring to FIG. 3, system 200 may be implemented on a network device, an example of which is illustrated in FIG. 3 as a functional block diagram. Network device 300 may comprise a processor 302 and a memory 304 coupled to processor 302. Memory 304 may contain executable instructions that, when executed by processor 302, cause processor 302 to effectuate operations associated with translating parallel protocols between end points in families as described above. As evident from the description herein, network device 300 is not to be construed as software per se.

Referring further to FIG. 1D, data interface is 151 is configured to communicate with one or more infrastructure components 104 and/or one or more supplemental components 109. In one example, requests for VMD 121 functionality may be received or identified by data interface 151 and then routed to components of system 150 for processing. In one example, when a determination as to how to support the functionality of a VMD 121 request, implementation instructions may be transmitted through data interface 151 to one or more hardware platforms infrastructure components 104 or supplemental components 109.

Database 153 in one embodiment may include one or memory storage devices that include data relating to the operation of system 150 and/or the management of one or more hardware platforms 106 or VMDs 121 within a network infrastructure. Such data may include information, such as affinity rules, anti-affinity rules, and other deployment constraints that should be taken into account when managing VMDs 121 and VMD 121 requests. Such data may include information regarding the characteristics of VMDs 121.

For instance, each user 102 may have particular requirements for their VMD 121. One user 102 may expect an operating system, such iOS® 10.3.2 whereas another user may expect iOS® 9.35. The former user 102 may expect to have a very robust device with significant processing power, memory storage, and a plethora of applications. The latter user 102 may expect a lean device to be used to talk on the phone, perform light web browsing, and send text messages. Database 153 in one example would include VMD 121 configuration profiles that would provide a VMD 121 configuration for each user 102. As a user 102 requested certain functionality, implementation details 153 for the functionality could be retrieved from database 153.

In another example, an EPD 101 may be provided with the capability to formulate a device environment profile. Such a profile may be formulated by using sensors 110 near the EPD 101 or that are part of EPD 101. Such a profile may include characteristics of the environment that may affect bandwidth. The profile may be sent to system 150, which may store the profile in database 153 and/or use the profile to create an appropriate output stream for EPD 101. An example would be if EPD 101 were operating in a low bandwidth area, system 150 would cause network infrastructure devices 104 to provide a video output stream to EPD 101 that would have a reduced bit rate, such that it would not cause undue latency between execution of an application and output from EPD 101.

In another embodiment, system 150 may have the capability to formulate and/or enforce a user 102 identification profile. For example, system 150 may have the capability of determining an identity of a user 102 of an EPD 101 and to tailor a VPD 121 accordingly. Identity of a user 102 may be determined by one or more authentication credentials (username, biometric information, password, etc.) input by a user 102 to an EPD 101. In another embodiment, context may provide the identity of the user 102. For example, the location at which the EPD 101 is being used or the applications that are requested by the user 102. The VPD 121 may configure itself based on the identity of the user. For instance, a child may have one operating system and set of applications whereas a parent may have another. In another example, a child at school may a different set of applications then if the child where in another location, such home. Security mechanisms may be used to enforce the use of such use 102 identification profiles. In one example, certain resources, such as vApplications 121c may be mapped to certain EPD 101 hardware. In another embodiment, one EPD 101a may be notified if a particular VMD 121 is used on another EPD 101b.

There are a number of ways that profiles may be managed. In one example, there may be enterprise profiles, which provide an overlay for base permissions with respect to network infrastructure resources 104 and supplemental resources 109. For example, there may be profiles, such as school, family, company, and campus profiles. Changes to enterprise profiles may be propagated to derived profiles. There may be profile sub-layers. For example, within a family, there may be a parent profile and a child profile. Profiles may be cross-applied. For instance, a generic “family” profile from a service provider, may be cross-applied to profile of content provider, which would allow for customization based on interests.

Application management component 155 in one example manages the resources and applications that are used to perform the functionality of a VMD 121, such as vCPUs 121a, vMemories 121b, and/or vApplications 121c. For example, if a user 102 were to initiate the user of a particular application on EPD 101, application management component 155 may determine how and with what resources to initiate the application for the user 102. Application, management component 155 may utilize information in database 153 to make such a determination.

For example, if a user 102 initiated a particular game on an EPD 101, application management component 155 may identify and direct appropriate network resources, such as infrastructure devices 104 and supplemental devices, to instantiate the game on network 103. Application management component 155 may consult database 153 to determine whether or not there is user data that is needed to play the game and where such user data is located. Similarly application management component 155 may consult database 153 to identify and locate the application software that is necessary to provide the game experience to the user. Application management component 155 may send requests to hardware platforms 106 requesting that the game application be instantiated using resources, such as vCPU 121a, vMemory 121b, and vApplication 121c, and streamed to the EPD 101 of user 102. User 102 would then commence playing the game as if the game where executing locally on EPD 101 of the user 102. To the extent the user needed to control an aspect of the game, the user 102 would input commands through the UI 101 of the EPD 101, which would then be received by the application(s) 121a, executing on VMD 121, which would respond calculate a response, and send an updated stream to the VMD 121.

Hardware management component 157 in one example is utilized to manage supplemental devices 109 that a user 102 would like to utilize as part of a VMD 121. For example, if a user expected a plurality of home automation sensors to function as part of the VMD 121, then hardware management component 157 would identify, locate and manage these devices in conjunction with operation of the applications that use their data. Hardware management component 157 may use information in database 153 and/or or contact supplemental devices 109 (e.g. through polling) to perform these functions.

Presentation management component 159, in one example, is utilized to manage the rendering of data on EPDs 101. For instance, an EPD 101 may have a low resolution or high resolution screen. It would not make sense to send high resolution data to a low resolution screen. Accordingly, presentation management component 159 may identify an appropriate resolution and direct infrastructure devices 104 to send data to the EPD 101 in the correct resolution. In another example, presentation management component 159 may determine user interfaces that a user 102 requires and insure that such interfaces are provided to the EPD 101 of user. For instance, a user 102 may watch a video utilizing an operating system that allows a user to make a pinch gesture on touch screen to zoom the video application. Presentation management component 159 may insert a control in the video stream that allows a user 102 to zoom by making a pinch gesture on a screen of an EPD 101.

It should be noted that there are different ways to implement VMD 121 functionality. In one example, a user may actuate a VMD 121 by entering an input into EPD 101. A request may be sent to system 150 to actuate VMD 121 in its totality for the user 102. That is, all of the user's 102 expected functionality may be instantiated at once. The user interface for such functionality may be sent in a persistent state the EPD 101 of user 102. For example, expected functionality of iOS device would be instantiated and the iOS interface would be sent to the EPD 101 of the user 102. The user 102 would then interact with EPD 101 to execute certain applications and/or functionality. Because such applications and/or functionality would be already be instantiated, the user interface on EPD 101 would change accordingly, but new applications and/or functionality would not have to be instantiated

In another example, the expected functionality may be instantiated on an on-demand basis. For instance, upon actuation a home screen of an operating system user interface may be sent in a persistent state to EPD 101 of user 102. As the user 102, actuates functionality, the system 150 would direct network resources, such as infrastructure devices 104 and supplemental devices 150 to instantiate the functionality. When the user 102 no longer needed such functionality, which the user 102 may signify by closing an application, system 150 would direct network resources to terminate the functionality and allow the resources to be used by another user 102.

In another example, a VMD 121 may provide multiple video streams to an EPD 101. For instance, a VMD 121 may run two applications simultaneously. Each application may have its own video stream. The video streams may be sent to an EPD 101 using a protocol, such as MPEG 7, that allows multiple video streams to be placed on a display screen. In this manner, two or more applications could run simultaneously and their execution could be displayed on the EPD 101 simultaneously. In another example, a plurality of VMDs 121 could each provide a video stream to an EPD 101 simultaneously. Therefore, one EPD 101 could be utilized by a user 102 to operate to VMDs 121 simultaneously.

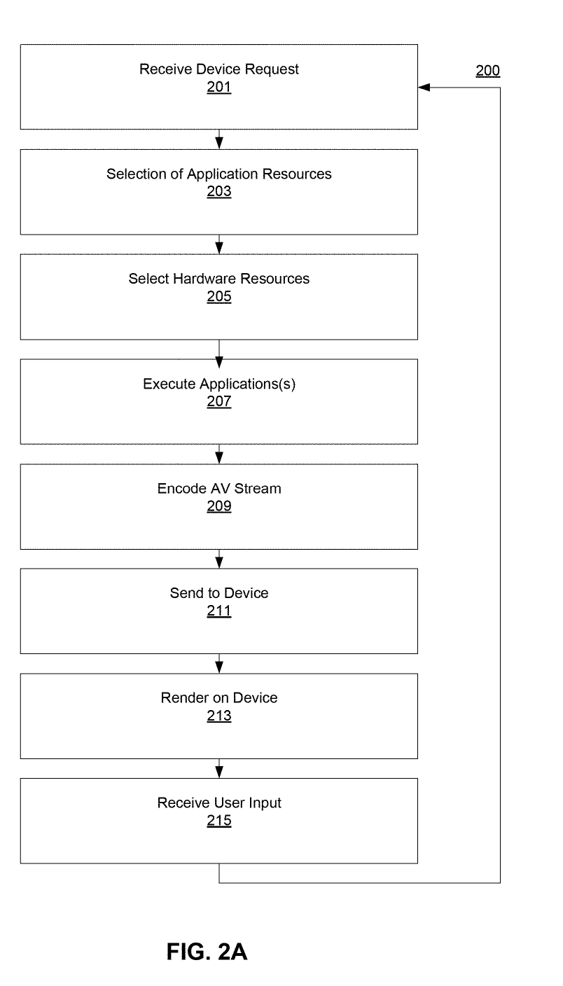

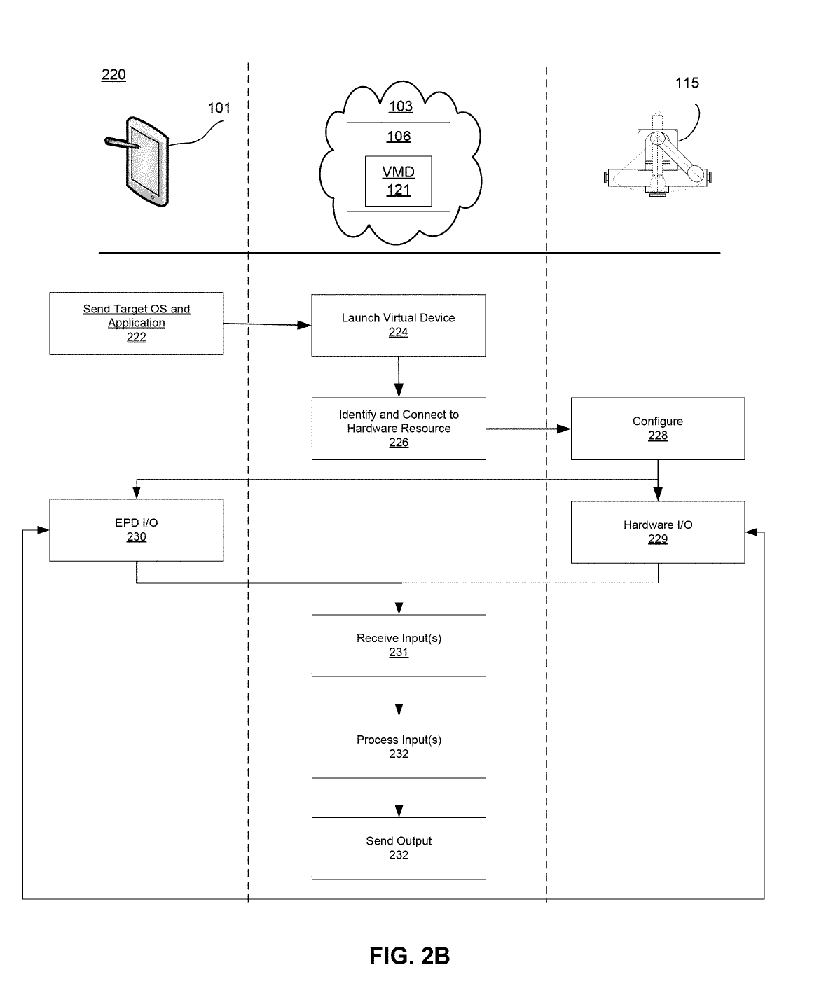

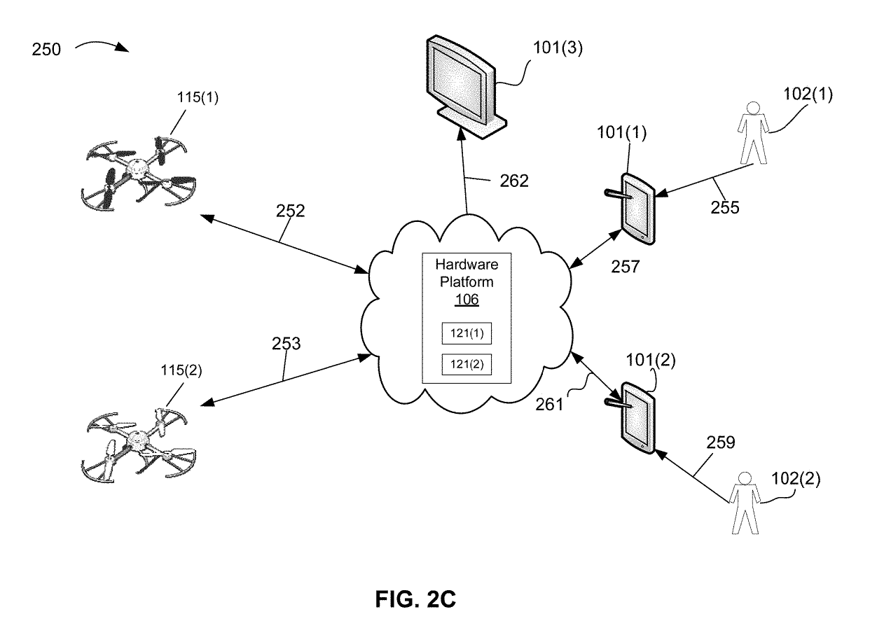

Referring FIG. 2A, an exemplary process 200 for managing VMDs 121 is now provided for illustrative purposes.

In step 201, one or more VMD 121 requests are received. A VMD 121 request may take many forms. In one example, a VMD 121 request may be a user 102 interaction with an EPD 101 in which the user wants the VMD 121 to perform some function, such as the interactions described above with respect to FIG. 1D. In another embodiment, a VMD 121 request may be to add or change the functionality of a VMD 121. For example, a user 102 may request a new operating system or a new application. In another example, a user 102 may request that parental controls be added to a VMD 121. In another example, a user 102 may request a new hardware configuration, such as a new CPU or additional memory. In another example, a user may request an entirely new VMD 121.

In step 203, a selection of application resources occurs. For instance, a user 102 may request a particular gaming application or word processing application. System 150 would make a determination as to how to serve the application to the user 102 by using network infrastructure resources 104 and supplemental resources 109. System 150 may use profile data in database 153 to make this determination or may poll network infrastructure resources 104 and supplemental resources 109 for availability.

In step 205 a selection of hardware resources occurs. For instance, a selection of a user 102 may specify or require a VPD 121 to include a particular processor or peripheral component. System 150 would make a determination as to how to provide virtual resources to the user 102. System 150 may use profile data in database 153 to make this determination or may poll network infrastructure resources 104 and supplemental resources 109 for availability

In step 207, applications are executed. In one example, referring to FIG. 1C, this means that vCPUs 121a, vMemories 121b, vApplications 121c, and any supplemental devices 109 operate to perform the functionality requested by the user 102.

In step 209, the output of step 207 is encoded into an AV stream and sent to EPD 101 in step 211. Such output may include controls that provide the opportunity for the user to provide response to the output of step 207.

In step 213 the output is rendered on EPD 101. In one example, interaction objects, such as “fade”, “swipe”, “zoom”, or “next screen” may be sent to the EPD 101 as image assets. A video decoder on the EPD 101 can execute these transitions (“fade, “zoom”, “move”) as a user provides input through these assets.

In step 215, user input is received from user 102 at which point the method returns to step 201, wherein the process 200 may repeat itself in order to provide the user 102 with additional interactive experience.

Referring to FIG. 2B, an exemplary process 220 of utilizing an EPD 101 to operate a machine 115 is shown for illustrative purposes. In step 222, EPD 101, after receiving user input, sends a request for a target OS and application to networks 103. In one example, system 150 receives such a request and instantiates a VMD 121 in step 224. Instantiating a VMD 121 in one example comprises launching an application that controls machine 115 on the target OS. The application may be utilize a vCPU 121a, vMemory 121b, and vApplication 121c. In step 226, system 150 identifies hardware resources and VMD 121 connects to the hardware resources. In the current example, VMD 121 identifies and connects to machine 115. In step 228, machine 115 is configured for operation with VMD 121. In steps 229 and 230, interaction occurs between user 102 and machine 115. Interaction may occur by machine 115 providing data or sensor input in step 229 or user 102 providing input through EPD 101 in step 230. In step 231, VMD 121 receives the input. In step 232, VMD 121 processes the input, and in step 232 the VMD sends output to EPD 101 and/or machine 115.

Referring to FIG. 2C, an exemplary system 250 is shown by which a first user 102(1) and a second user 102(2) can control two machines 115(1), 115(2) is shown for illustrative purposes. In the example, machine 115(1) is a drone and machine 115(2) is a drone. User 102(1) and user 102(2) may use respective EPDs 101(1), 101(2) to control the drones 115(1), 115(2). The drones 115(1), 115(2) may be configured to perform a demonstration, such as a drone race, acrobatic display, or flying in formation. A hardware platform 106 may reside on network 103. Hardware platform 106 may instantiate respective VMDs 121(1), 121(2) by which user 102(1) may control drone 115(1) and user 102(2) may control drone 115(2). Drone 115(1) and VMD 121(1) in one example have a data stream 252 for exchange of data. Drone 115(2) and VMD 121(2) in one example have a data stream 253 for exchange of data. Drones 115(1), 115(2) in one example include gyroscopic sensors, navigation sensors, and video sensors. Accordingly, data streams 252, 253 in one example include gyroscopic data, navigation data, and video data. EPDs 101(1), 101(2) exchange data 257, 261 with their respective EPDs 101(1), 101(1). Data 257, 261 may include video data and user input 255, 259. For instance, an application executing on a VMD 121(1) may send video data of an interface showing a location and altitude of 115(1) to EPD 101(1). User 102(1) may provide input 255 into the interface that would control drone 115(1). The input would then be received by EPD 101(1) and transmitted to the VMD 121(1) executing the application controlling drone 115(1). User 102(1) can control drone 115(1) with a lean EPD 101 having a user interface and video rendering capability. In addition, another EPD 101(3) may be utilized to receive a stream 262 which may be one way stream of video data depicting the application controlling drone 115(1) and/or the application controlling drone 115(2) may be received. A spectator could then view the demonstration on another EPD 101(3).

Referring to FIG. 3, a system 200 may be implemented on a network device, an example of which is illustrated in FIG. 3 as a functional block diagram. Network device 300 may comprise a processor 302 and a memory 304 coupled to processor 302. Memory 304 may contain executable instructions that, when executed by processor 302, cause processor 302 to effectuate operations associated with translating parallel protocols between end points in families as described above. As evident from the description herein, network device 300 is not to be construed as software per se.

In addition to processor 302 and memory 304, network device 300 may include an input/output system 306. Processor 302, memory 304, and input/output system 306 may be coupled together to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), electrical means, or a combination thereof. In an example configuration, input/output system 306 may comprise a Wi-Fi finder, a two-way GPS chipset or equivalent, or the like, or a combination thereof. Bluetooth, infrared, NFC, and Zigbee are generally considered short range (e.g., few centimeters to 20 meters). WiFi is considered medium range (e.g., approximately 100 meters).

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

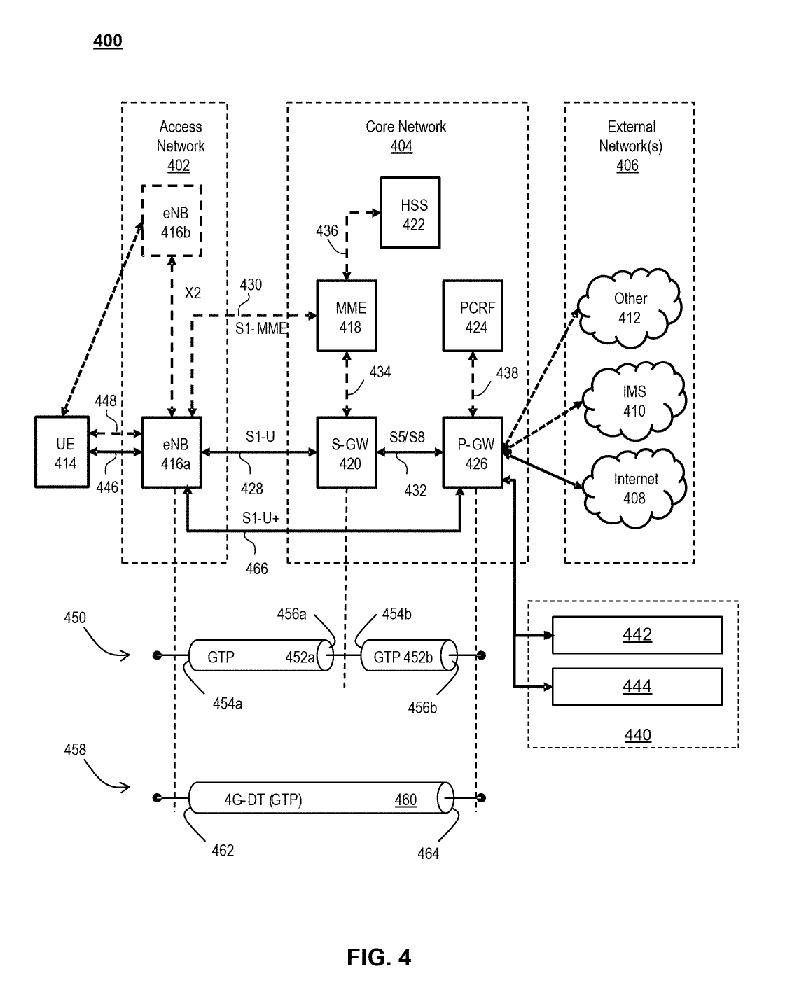

FIG. 4 illustrates a functional block diagram depicting one example of an LTE-EPS network architecture 400 that may be at least partially implemented as an SDN. Network architecture 400 disclosed herein is referred to as a modified LTE-EPS architecture 400 to distinguish it from a traditional LTE-EPS architecture.

An example modified LTE-EPS architecture 400 is based at least in part on standards developed by the 3rd Generation Partnership Project (3GPP), with information available at www.3gpp.org. LTE-EPS network architecture 400 may include an access network 402, a core network 404, e.g., an EPC or Common BackBone (CBB) and one or more external networks 406, sometimes referred to as PDN or peer entities. Different external networks 406 can be distinguished from each other by a respective network identifier, e.g., a label according to DNS naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like. In an aspect, access network 402, core network 404, or external network 405 may include or communicate with network 100.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as UE 414, and one or more wireless access nodes, or base stations 416a, 416b. During network operations, at least one base station 416 communicates directly with UE 414. Base station 416 can be an evolved Node B (e-NodeB), with which UE 414 communicates over the air and wirelessly. UEs 414 can include, without limitation, wireless devices, e.g., satellite communication systems, portable digital assistants (PDAs), laptop computers, tablet devices and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, VoIP, streaming media and the like. Each application can pose different Quality of Service (QoS) requirements on a respective packet transfer. Different packet transfers can be served by different bearers within core network 404, e.g., according to parameters, such as the QoS.

Core network 404 uses a concept of bearers, e.g., EPS bearers, to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as MME 418, SGW 420, Home Subscriber Server (HSS) 422, Policy and Charging Rules Function (PCRF) 424 and PGW 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths and/or interfaces are terms that can include features, methodologies, and/or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state, and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), and/or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity 406, and triggers paging of UE 414 when data arrives for UE 414. If UE 414 responds to the page, SGW 420 can forward the IP packet to eNB 416a.

HSS 422 can manage subscription-related information for a user of UE 414. For example, tHSS 422 can store information such as authorization of the user, security requirements for the user, quality of service (QoS) requirements for the user, etc. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as 51, X2, S5, S8, S11 refer to EPS interfaces. In some instances, such interface designations are combined with a suffix, e.g., a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an S6a signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring and/or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory and/or disk drive. It is understood that storage device 440 can include registers suitable for storing address values. Alternatively or in addition, storage device 440 can be separate from PGW 426, for example, as an external hard drive, a flash drive, and/or network storage.

Storage device 440 selectively stores one or more values relevant to the forwarding of packet data. For example, storage device 440 can store identities and/or addresses of network entities, such as any of network nodes 418, 420, 422, 424, and 426, eNBs 416 and/or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read and/or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address” for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, and/or other data structures generally well understood and suitable for maintaining and/or otherwise manipulate forwarding addresses on a per bearer basis.

It should be noted that access network 402 and core network 404 are illustrated in a simplified block diagram in FIG. 4. In other words, either or both of access network 402 and the core network 404 can include additional network elements that are not shown, such as various routers, switches and controllers. In addition, although FIG. 4 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an S1 data bearer 428) between eNB 416a and SGW 420, and a third portion (e.g., an S5/S8 bearer 432) between SGW 420 and PGW 426. Various signaling bearer portions are also illustrated in FIG. 4. For example, a first signaling portion (e.g., a signaling radio bearer 448) between UE 414 and eNB 416a, and a second signaling portion (e.g., S1 signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 100, e.g., by one or more of tunnel endpoint identifiers, an IP address and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between eNB 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two tunnel solution, e.g., according to the GPRS Tunneling Protocol User Plane (GTPv1-U based), as described in 3GPP specification TS 29.281, incorporated herein in its entirety. It is understood that one or more tunnels are permitted between each set of tunnel end points. For example, each subscriber can have one or more tunnels, e.g., one for each PDP context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. That is, SGW 420 can serve a relay function, by relaying packets between two tunnel endpoints 416a, 426. In other scenarios, direct tunneling solution 458 can forward user data packets between eNB 416a and PGW 426, by way of the S1 U+ interface, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual bases. That is, if user data packets of one bearer, say a bearer associated with a VoIP service of UE 414, then the forwarding of all packets of that bearer are handled in a similar manner. Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 414, eNB 416, MME 418, SGW 420, HSS 422, PCRF 424, PGW 426 and other devices of FIGS. 1, 2, and 4. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

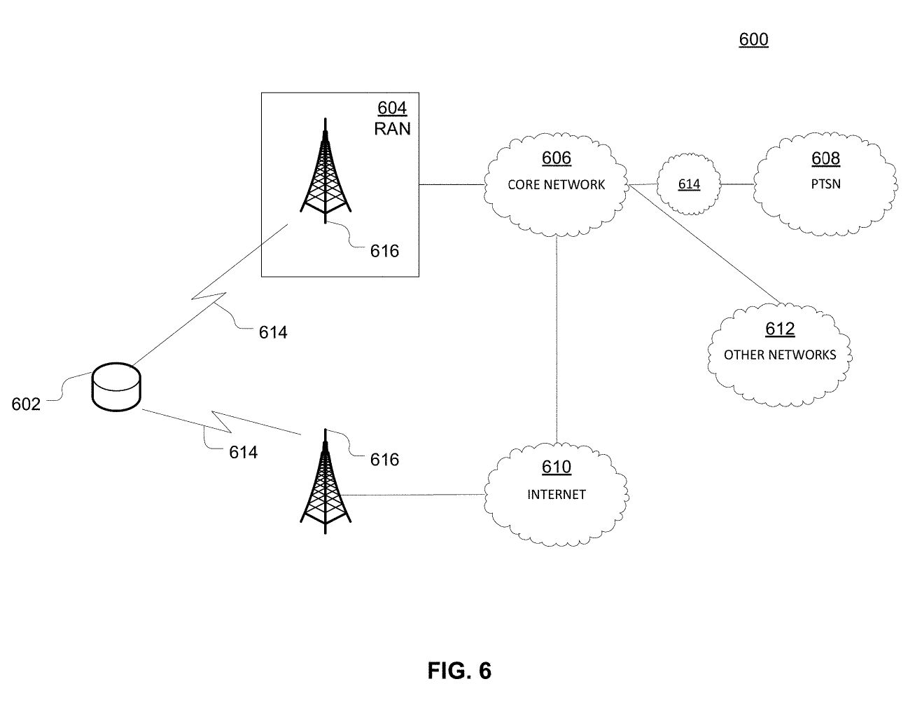

As shown in FIG. 6, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may comprise drone 102, a mobile device, network device 300, or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNode B, a Home Node B, a Home eNode B, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNode B, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, etc.) to establish a picocell or femtocell. As shown in FIG. 6, base station 616 may have a direct connection to Internet 610. Thus, base station 616 may not be required to access Internet 610 via core network 606.

RAN 604 may be in communication with core network 606, which may be any type of network configured to provide voice, data, applications, and/or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 6, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 614 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. That is, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

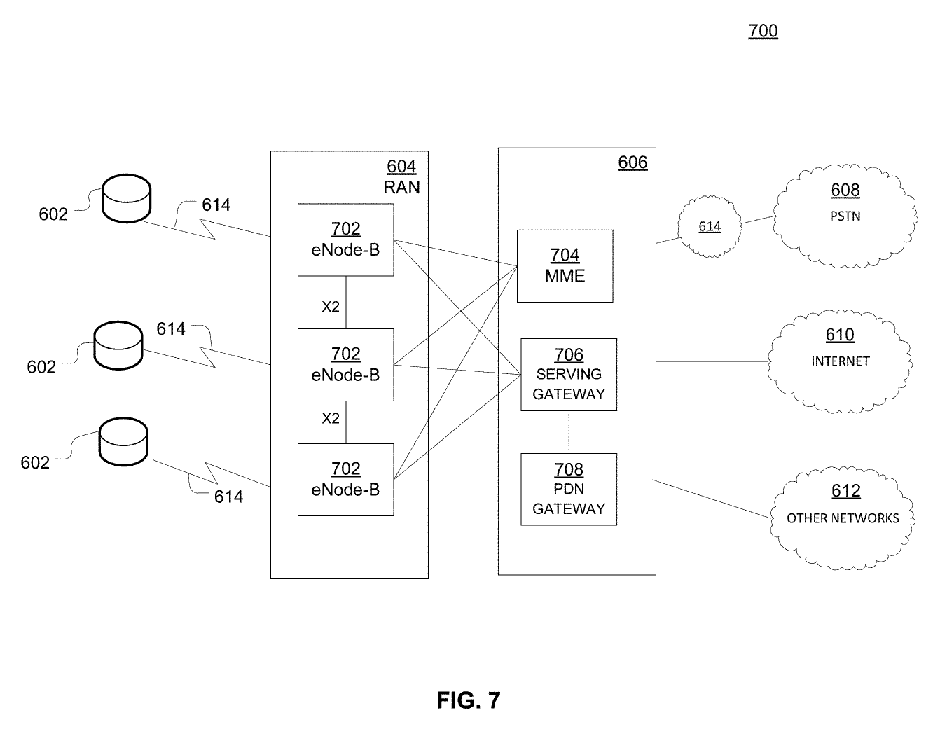

FIG. 7 is an example system 700 including RAN 604 and core network 606. As noted above, RAN 604 may employ an E-UTRA radio technology to communicate with WTRUs 602 over air interface 614. RAN 604 may also be in communication with core network 606.

RAN 604 may include any number of eNode-Bs 702 while remaining consistent with the disclosed technology. One or more eNode-Bs 702 may include one or more transceivers for communicating with the WTRUs 602 over air interface 614. Optionally, eNode-Bs 702 may implement MIMO technology. Thus, one of eNode-Bs 702, for example, may use multiple antennas to transmit wireless signals to, or receive wireless signals from, one of WTRUs 602.

Each of eNode-Bs 702 may be associated with a particular cell and may be configured to handle radio resource management decisions, handover decisions, scheduling of users in the uplink or downlink, or the like. As shown in FIG. 7 eNode-Bs 702 may communicate with one another over an X2 interface.

Core network 606 shown in FIG. 7 may include a mobility management gateway or entity (MME) 704, a serving gateway 706, or a packet data network (PDN) gateway 708. While each of the foregoing elements are depicted as part of core network 606, it will be appreciated that any one of these elements may be owned or operated by an entity other than the core network operator.

MME 704 may be connected to each of eNode-Bs 702 in RAN 604 via an S1 interface and may serve as a control node. For example, MME 704 may be responsible for authenticating users of WTRUs 602, bearer activation or deactivation, selecting a particular serving gateway during an initial attach of WTRUs 602, or the like. MME 704 may also provide a control plane function for switching between RAN 604 and other RANs (not shown) that employ other radio technologies, such as GSM or WCDMA.

Serving gateway 706 may be connected to each of eNode-Bs 702 in RAN 604 via the S1 interface. Serving gateway 706 may generally route or forward user data packets to or from the WTRUs 602. Serving gateway 706 may also perform other functions, such as anchoring user planes during inter-eNode B handovers, triggering paging when downlink data is available for WTRUs 602, managing or storing contexts of WTRUs 602, or the like.

Serving gateway 706 may also be connected to PDN gateway 708, which may provide WTRUs 602 with access to packet-switched networks, such as Internet 610, to facilitate communications between WTRUs 602 and IP-enabled devices.

Core network 606 may facilitate communications with other networks. For example, core network 606 may provide WTRUs 602 with access to circuit-switched networks, such as PSTN 608, such as through IMS core 614, to facilitate communications between WTRUs 602 and traditional land-line communications devices. In addition, core network 606 may provide the WTRUs 602 with access to other networks 612, which may include other wired or wireless networks that are owned or operated by other service providers.

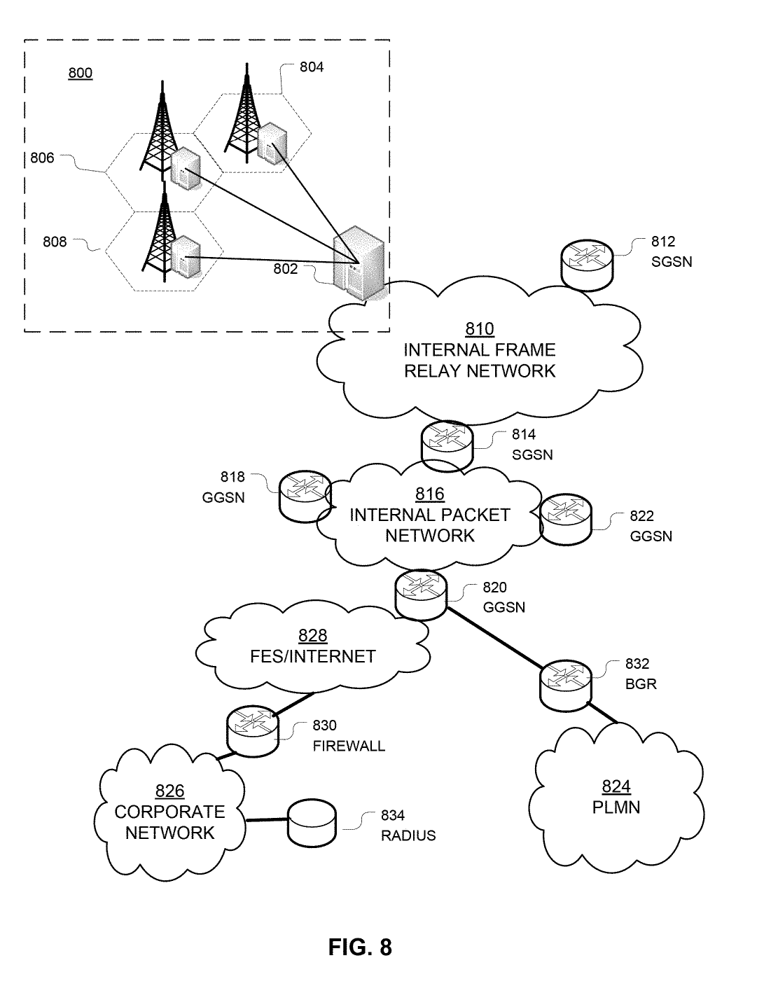

FIG. 8 depicts an overall block diagram of an example packet-based mobile cellular network environment, such as a GPRS network as described herein. In the example packet-based mobile cellular network environment shown in FIG. 8, there are a plurality of base station subsystems (BSS) 800 (only one is shown), each of which comprises a base station controller (BSC) 802 serving a plurality of BTSs, such as BTSs 804, 806, 808. BTSs 804, 806, 808 are the access points where users of packet-based mobile devices become connected to the wireless network. In example fashion, the packet traffic originating from mobile devices is transported via an over-the-air interface to BTS 808, and from BTS 808 to BSC 802. Base station subsystems, such as BSS 800, are a part of internal frame relay network 810 that can include a service GPRS support nodes (SGSN), such as SGSN 812 or SGSN 814. Each SGSN 812, 814 is connected to an internal packet network 816 through which SGSN 812, 814 can route data packets to or from a plurality of gateway GPRS support nodes (GGSN) 818, 820, 822. As illustrated, SGSN 814 and GGSNs 818, 820, 822 are part of internal packet network 816. GGSNs 818, 820, 822 mainly provide an interface to external IP networks such as PLMN 824, corporate intranets/internets 826, or Fixed-End System (FES) or the public Internet 828. As illustrated, subscriber corporate network 826 may be connected to GGSN 820 via a firewall 830. PLMN 824 may be connected to GGSN 820 via a border gateway router (BGR) 832. A Remote Authentication Dial-In User Service (RADIUS) server 834 may be used for caller authentication when a user calls corporate network 826.

Generally, there may be a several cell sizes in a network, referred to as macro, micro, pico, femto or umbrella cells. The coverage area of each cell is different in different environments. Macro cells can be regarded as cells in which the base station antenna is installed in a mast or a building above average roof top level. Micro cells are cells whose antenna height is under average roof top level. Micro cells are typically used in urban areas. Pico cells are small cells having a diameter of a few dozen meters. Pico cells are used mainly indoors. Femto cells have the same size as pico cells, but a smaller transport capacity. Femto cells are used indoors, in residential or small business environments. On the other hand, umbrella cells are used to cover shadowed regions of smaller cells and fill in gaps in coverage between those cells.

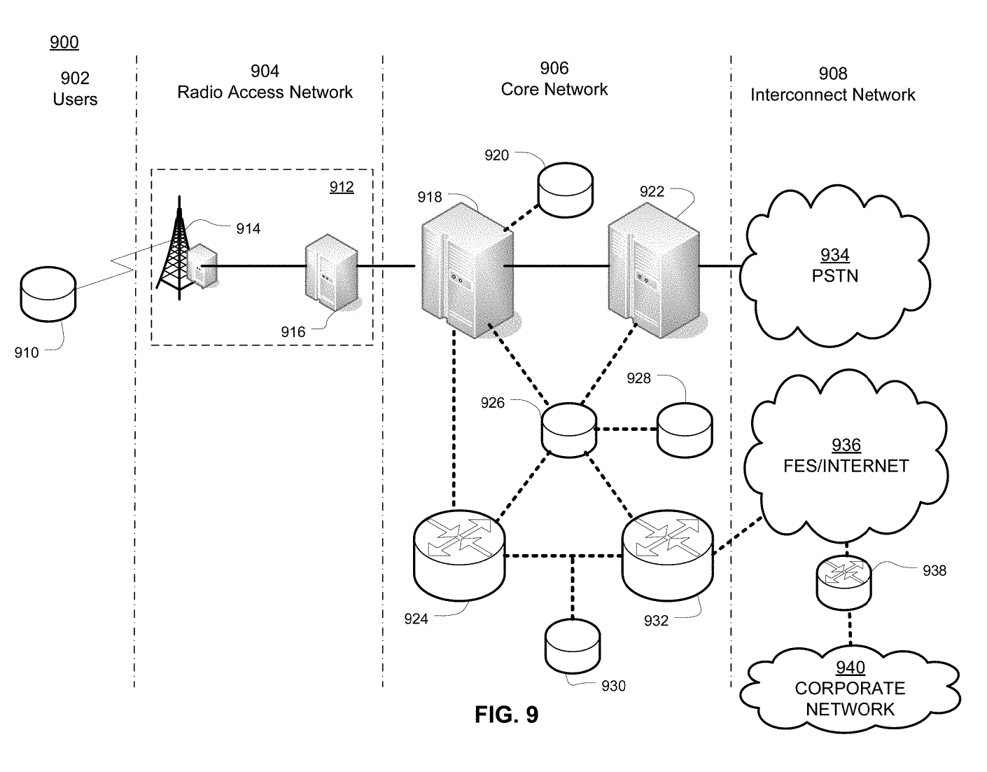

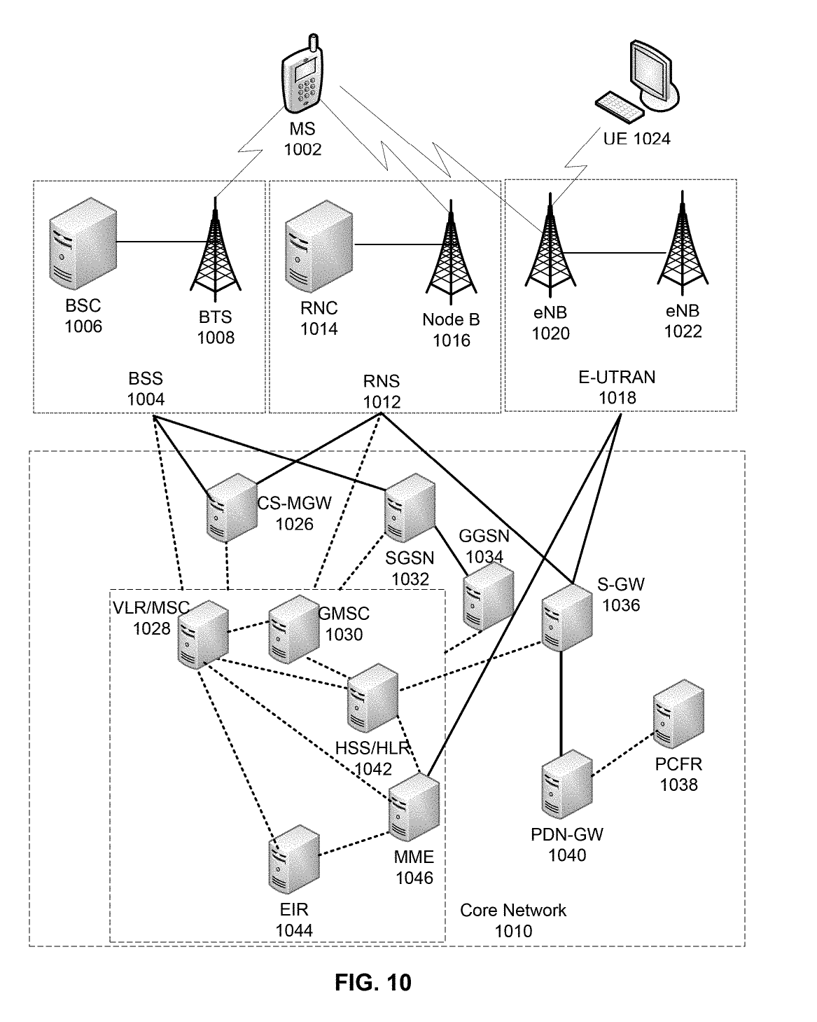

FIG. 9 illustrates an architecture of a typical GPRS network 900 as described herein. The architecture depicted in FIG. 9 may be segmented into four groups: users 902, RAN 904, core network 906, and interconnect network 908. Users 902 comprise a plurality of end users, who each may use one or more devices 910. Note that device 910 is referred to as a mobile subscriber (MS) in the description of network shown in FIG. 9. In an example, device 910 comprises a communications device (e.g., mobile device 102, mobile positioning center 116, network device 300, any of detected devices 500, second device 508, access device 604, access device 606, access device 608, access device 610 or the like, or any combination thereof). Radio access network 904 comprises a plurality of BSSs such as BSS 912, which includes a BTS 914 and a BSC 916. Core network 906 may include a host of various network elements. As illustrated in FIG. 9, core network 906 may comprise MSC 918, service control point (SCP) 920, gateway MSC (GMSC) 922, SGSN 924, home location register (HLR) 926, authentication center (AuC) 928, domain name system (DNS) server 930, and GGSN 932. Interconnect network 908 may also comprise a host of various networks or other network elements. As illustrated in FIG. 9, interconnect network 908 comprises a PSTN 934, an FES/Internet 936, a firewall 1038(FIG. 10), or a corporate network 940.

An MSC can be connected to a large number of BSCs. At MSC 918, for instance, depending on the type of traffic, the traffic may be separated in that voice may be sent to PSTN 934 through GMSC 922, or data may be sent to SGSN 924, which then sends the data traffic to GGSN 932 for further forwarding.

When MSC 918 receives call traffic, for example, from BSC 916, it sends a query to a database hosted by SCP 920, which processes the request and issues a response to MSC 918 so that it may continue call processing as appropriate.

HLR 926 is a centralized database for users to register to the GPRS network. HLR 926 stores static information about the subscribers such as the International Mobile Subscriber Identity (IMSI), subscribed services, or a key for authenticating the subscriber. HLR 926 also stores dynamic subscriber information such as the current location of the MS. Associated with HLR 926 is AuC 928, which is a database that contains the algorithms for authenticating subscribers and includes the associated keys for encryption to safeguard the user input for authentication.

In the following, depending on context, “mobile subscriber” or “MS” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 9, when MS 910 initiates the attach process by turning on the network capabilities of the mobile device, an attach request is sent by MS 910 to SGSN 924. The SGSN 924 queries another SGSN, to which MS 910 was attached before, for the identity of MS 910. Upon receiving the identity of MS 910 from the other SGSN, SGSN 924 requests more information from MS 910. This information is used to authenticate MS 910 together with the information provided by HLR 926. Once verified, SGSN 924 sends a location update to HLR 926 indicating the change of location to a new SGSN, in this case SGSN 924. HLR 926 notifies the old SGSN, to which MS 910 was attached before, to cancel the location process for MS 910. HLR 926 then notifies SGSN 924 that the location update has been performed. At this time, SGSN 924 sends an Attach Accept message to MS 910, which in turn sends an Attach Complete message to SGSN 924.

Next, MS 910 establishes a user session with the destination network, corporate network 940, by going through a Packet Data Protocol (PDP) activation process. Briefly, in the process, MS 910 requests access to the Access Point Name (APN), for example, UPS.com, and SGSN 924 receives the activation request from MS 910. SGSN 924 then initiates a DNS query to learn which GGSN 932 has access to the UPS.com APN. The DNS query is sent to a DNS server within core network 906, such as DNS server 930, which is provisioned to map to one or more GGSNs in core network 906. Based on the APN, the mapped GGSN 932 can access requested corporate network 940. SGSN 924 then sends to GGSN 932 a Create PDP Context Request message that contains necessary information. GGSN 932 sends a Create PDP Context Response message to SGSN 924, which then sends an Activate PDP Context Accept message to MS 910.

Once activated, data packets of the call made by MS 910 can then go through RAN 904, core network 906, and interconnect network 908, in a particular FES/Internet 936 and firewall 1038, to reach corporate network 940.

FIG. 10 illustrates a block diagram of an example PLMN architecture that may be replaced by a telecommunications system. In FIG. 10, solid lines may represent user traffic signals, and dashed lines may represent support signaling. MS 1002 is the physical equipment used by the PLMN subscriber. For example, drone 102, network device 300, the like, or any combination thereof may serve as MS 1002. MS 1002 may be one of, but not limited to, a cellular telephone, a cellular telephone in combination with another electronic device or any other wireless mobile communication device.

MS 1002 may communicate wirelessly with BSS 1004. BSS 1004 contains BSC 1006 and a BTS 1008. BSS 1004 may include a single BSC 1006/BTS 1008 pair (base station) or a system of BSC/BTS pairs that are part of a larger network. BSS 1004 is responsible for communicating with MS 1002 and may support one or more cells. BSS 1004 is responsible for handling cellular traffic and signaling between MS 1002 and a core network 1010. Typically, BSS 1004 performs functions that include, but are not limited to, digital conversion of speech channels, allocation of channels to mobile devices, paging, or transmission/reception of cellular signals.

Additionally, MS 1002 may communicate wirelessly with RNS 1012. RNS 1012 contains a Radio Network Controller (RNC) 1014 and one or more Nodes B 1016. RNS 1012 may support one or more cells. RNS 1012 may also include one or more RNC 1014/Node B 1016 pairs or alternatively a single RNC 1014 may manage multiple Nodes B 1016. RNS 1012 is responsible for communicating with MS 1002 in its geographically defined area. RNC 1014 is responsible for controlling Nodes B 1016 that are connected to it and is a control element in a UMTS radio access network. RNC 1014 performs functions such as, but not limited to, load control, packet scheduling, handover control, security functions, or controlling MS 1002 access to core network 1010.

An E-UTRA Network (E-UTRAN) 1018 is a RAN that provides wireless data communications for MS 1002 and UE 1024. E-UTRAN 1018 provides higher data rates than traditional UMTS. It is part of the LTE upgrade for mobile networks, and later releases meet the requirements of the International Mobile Telecommunications (IMT) Advanced and are commonly known as a 4G networks. E-UTRAN 1018 may include of series of logical network components such as E-UTRAN Node B (eNB) 1020 and E-UTRAN Node B (eNB) 1022. E-UTRAN 1018 may contain one or more eNBs. User equipment (UE) 1024 may be any mobile device capable of connecting to E-UTRAN 1018 including, but not limited to, a personal computer, laptop, mobile device, wireless router, or other device capable of wireless connectivity to E-UTRAN 1018. The improved performance of the E-UTRAN 1018 relative to a typical UMTS network allows for increased bandwidth, spectral efficiency, and functionality including, but not limited to, voice, high-speed applications, large data transfer or IPTV, while still allowing for full mobility.

Typically MS 1002 may communicate with any or all of BSS 1004, RNS 1012, or E-UTRAN 1018. In a illustrative system, each of BSS 1004, RNS 1012, and E-UTRAN 1018 may provide MS 1002 with access to core network 1010. Core network 1010 may include of a series of devices that route data and communications between end users. Core network 1010 may provide network service functions to users in the circuit switched (CS) domain or the packet switched (PS) domain. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The circuit-switched MGW function (CS-MGW) 1026 is part of core network 1010, and interacts with VLR/MSC server 1028 and GMSC server 1030 in order to facilitate core network 1010 resource control in the CS domain. Functions of CS-MGW 1026 include, but are not limited to, media conversion, bearer control, payload processing or other mobile network processing such as handover or anchoring. CS-MGW 1026 may receive connections to MS 1002 through BSS 1004 or RNS 1012.

SGSN 1032 stores subscriber data regarding MS 1002 in order to facilitate network functionality. SGSN 1032 may store subscription information such as, but not limited to, the IMSI, temporary identities, or PDP addresses. SGSN 1032 may also store location information such as, but not limited to, GGSN address for each GGSN 1034 where an active PDP exists. GGSN 1034 may implement a location register function to store subscriber data it receives from SGSN 1032 such as subscription or location information.

Serving gateway (S-GW) 1036 is an interface which provides connectivity between E-UTRAN 1018 and core network 1010. Functions of S-GW 1036 include, but are not limited to, packet routing, packet forwarding, transport level packet processing, or user plane mobility anchoring for inter-network mobility. PCRF 1038 uses information gathered from P-GW 1036, as well as other sources, to make applicable policy and charging decisions related to data flows, network resources or other network administration functions. PDN gateway (PDN-GW) 1040 may provide user-to-services connectivity functionality including, but not limited to, GPRS/EPC network anchoring, bearer session anchoring and control, or IP address allocation for PS domain connections.

HSS 1042 is a database for user information and stores subscription data regarding MS 1002 or UE 1024 for handling calls or data sessions. Networks may contain one HSS 1042 or more if additional resources are required. Example data stored by HSS 1042 include, but is not limited to, user identification, numbering or addressing information, security information, or location information. HSS 1042 may also provide call or session establishment procedures in both the PS and CS domains.

VLR/MSC Server 1028 provides user location functionality. When MS 1002 enters a new network location, it begins a registration procedure. A MSC server for that location transfers the location information to the VLR for the area. A VLR and MSC server may be located in the same computing environment, as is shown by VLR/MSC server 1028, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for MS 1002 registration or procedures for handover of MS 1002 to a different section of core network 1010. GMSC server 1030 may serve as a connection to alternate GMSC servers for other MSs in larger networks.

EIR 1044 is a logical element which may store the IMEI for MS 1002. User equipment may be classified as either “white listed” or “black listed” depending on its status in the network. If MS 1002 is stolen and put to use by an unauthorized user, it may be registered as “black listed” in EIR 1044, preventing its use on the network. A MME 1046 is a control node which may track MS 1002 or UE 1024 if the devices are idle. Additional functionality may include the ability of MME 1046 to contact idle MS 1002 or UE 1024 if retransmission of a previous session is required.

As described herein, a telecommunications system wherein management and control utilizing a software designed network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which virtual devices may be managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

1. A system for providing virtual mobile device services over a network to a mobile endpoint device, comprising:
a processor, an input/output device coupled to the processor, and a memory coupled to the processor, the memory comprising executable instructions that when executed by the processor cause the processor to effectuate operations comprising:
receiving user input from a mobile endpoint device;
identifying, in response to the user input, at least one network resource, and at least one virtual machine (VM) to generate in response to the user input;
utilizing the at least one network resource to instantiate the at least one VM and generate the response to the user input;
generating an audiovisual data stream representing the response to the user input; and
causing the audiovisual data stream to be output to the mobile endpoint device.

2. The system of claim 1, wherein the at least one resource comprises at least one of a server, a network switch, and a router.

3. The system of claim 2, wherein the at least one resource further comprises at least one of a peripheral device, a sensor, and an internet of things (TOT) device.

4. The system of claim 1, wherein the audiovisual data stream includes a control element that enables a user to enter the user input into the mobile endpoint device.

5. The system of claim 1, wherein the at least one VM comprises an application software program operating with at least one of a virtual CPU and a virtual memory.

6. The system of claim 1, wherein the at least one VM comprises a plurality of VMs operating on a plurality of servers.

7. The system of claim 1, wherein the at least one VM comprises a mobile device operating system operating with at least one of the virtual CPU and the virtual memory.

8. The system of claim 7, wherein the operations further comprise:
receiving a request from the mobile endpoint device to change the mobile device operating system to another mobile device operating system.

9. The system of claim 8, wherein the operations further comprise:
instantiating at least one other VM to execute the other mobile device operating system.

10. The system of claim 1, wherein the operations further comprise:
determining from a profile at least one characteristic of the mobile endpoint device; and
generating the audiovisual data stream in response to determining the at least one characteristic.

11. A method for providing virtual mobile device services over a network to a mobile endpoint device, comprising:
receiving user input from a mobile endpoint device;
identifying, in response to the user input, at least one network resource, and at least one virtual machine (VM) to generate in response to the user input;
utilizing the at least one network resource to instantiate the at least one VM and generate the response to the user input;
generating an audiovisual data stream representing the response to the user input; and
causing the audiovisual data stream to be output to the mobile endpoint device.

12. The method of claim 11, wherein the at least one resource comprises at least one of a server, a network switch, and a router.

13. The method of claim 12, wherein the at least one resource further comprises at least one of a peripheral device, a sensor, and an internet of things (TOT) device.

14. The method of claim 11, wherein the audiovisual data stream includes a control element that enables a user to enter the user input into the mobile endpoint device.

15. The method of claim 11, wherein the at least one VM comprises an application software program operating with at least one of a virtual CPU and a virtual memory.

16. The method of claim 11, wherein the at least one VM comprises a plurality of VMs operating on a plurality of servers.

17. The method of claim 11, wherein the at least one VM comprises a mobile device operating system operating with at least one of the virtual CPU and the virtual memory.

18. The method of claim 17, further comprising:
receiving a request from the mobile endpoint device to change the mobile device operating system to another mobile device operating system.

19. The method of claim 18, further comprising:
instantiating at least one other VM to execute the other mobile device operating system.

20. The method of claim 11, further comprising:
determining from a profile at least one characteristic of the mobile endpoint device; and
generating the audiovisual data stream in response to determining the at least one characteristic.
